(19) United States
(12) Patent Application Publication
(10) Pub. No.: US 2010/0277472 A1
(43) Pub. Date: Nov. 4, 2010

(54) METHOD AND SYSTEM FOR CAPTURING 3D IMAGES OF A HUMAN BODY IN A MOMENT OF MOVEMENT

(76) Inventors: Christopher Kaltenbach, Tokyo (JP); Takeshi Ishiguro, Tokyo (JP)

Correspondence Address: ORTIZ & LOPEZ, PLLC, P.O. BOX 4484, ALBUQUERQUE, NM, 87196-4484, US

(21) Appl. No.: 12/756,890

(22) Filed: Apr. 8, 2010

Related U.S. Application Data
(60) Provisional application No. 61/168,132, filed on Apr. 9, 2009.

(51) Int. Cl. G06T 15/00

(52) U.S. Cl. 345/419

(57) ABSTRACT

A method and system for creating 3D laser-induced images of a body or bodies suspended in air within a transparent material by way of using a scanner (e.g., a laser scanner) to optically scan an environment and stop action. The same 3D data may be utilized construct portraits of individuals through 3D laser etching, 3D laser cutting, 3D printing/rendering (or any form of rapid prototyping). Multiple scanners such as scanners 102, 104, 106 and 108 can be utilized to capture a complete person three dimensionally—laser scans on all X, Y, Z planes, thereby enabling synchronizing scans. Such an approach further enables the construction of a complete three-dimensional data model from multiple data.

### CROSS-REFERENCE TO PROVISIONAL PATENT APPLICATION

This patent application claims priority to U.S. Provisional Patent Application Ser. No. 61/168,132, entitled “Method and System for Capturing 3D Images of a Human Body in a Moment of movement,” which was filed on Apr. 9, 2009 and is incorporated herein by reference in its entirety.

### TECHNICAL FIELD

Embodiments are generally related to the field of space tourism, adventure sports, amusement park rides, Olympic training facilities/games, and the like. Embodiments are also related to scanning devices and systems, such as, for example, LIDAR (Light Detection and Ranging) scanners and other types of scanners. Embodiments are additionally related to the rendering of 3D images of human bodies in motion.

### BACKGROUND OF THE INVENTION

Individuals who engage or view space tourism, adventure sports, amusement park rides, Olympic training facilities/games, and so forth, often desire a representation of the particular activity, as a keepsake or for archival purposes.

Space tourism, for example, is the recent phenomenon of tourists paying for flights into space pioneered by Russia. As of 2009, orbital space tourism opportunities are limited and expensive, with only the Russian Space Agency providing transport. The price for a flight brokered by Space Adventures to the International Space Station aboard a Soyuz spacecraft is $20-28 million. Infrastructure for a suborbital space tourism industry is being developed through the construction of spaceports in numerous locations, including California, Oklahoma, New Mexico, Florida, Virginia, Alaska, Wisconsin, Esrange in Sweden as well as the United Arab Emirates. Some use the term “personal spaceflight” as in the case of the Personal Spaceflight Federation.

On Oct. 4, 2004, the SpaceShipOne, designed by Burt Rutan of Scaled Composites and funded by Virgin Galactic, won the $10,000,000 Ansari X Prize, which was designed to be won by the first private company who could reach and surpass an altitude of 62 miles (100 km) twice within two weeks. The altitude is beyond the Karman Line, the arbitrarily defined boundary of space. The first flight was flown by Michael Melvill on Jun. 21, 2004 to a height of 62 miles, making him the first commercial astronaut. The prize-winning flight was flown by Brian Binnie, which reached a height of 69.6 miles, breaking the X-15 record. SpaceshipOne, the first privately funded and constructed spacecraft to fly above the 100 km Kármán Line.

Virgin Galactic, one of the leading potential space tourism groups, is planning to begin passenger service aboard the VSS Enterprise, a Scaled Composites SpaceShipTwo type spacecraft. The initial seat price will be $200,000, but that price is expected to eventually fall to $20,000. To date, over two hundred people have made down payments on bookings. Headed by Sir Richard Branson's Virgin Group, Virgin Galactic hopes to be the first private space tourism company to regularly send civilians into space. A citizen astronaut will only require three days of training before spaceflight. SpaceShipTwo will be a scaled up version of SpaceShipOne, the spacecraft which claimed the Ansari X Prize. Both spacecrafts were designed by Burt Rutan's Scaled Composites. Launches will initially occur at the Mojave Spaceport in California, and will then be moved to Spaceport America in Upham, N.M. Tourists may also be launched from Kiruna, Sweden.

The spacecraft will travel 360,000 feet (109.73 km/68.18 miles) high. This goes beyond the internationally defined boundary between Earth and space of 100 km. Spaceflights will last 2.5 hours, carry 6 passengers, and reach a speed of Mach 3. SpaceShipTwo will not require a space shuttle-like heat shield for atmospheric reentry as it will not experience the extreme aerodynamic heating experienced during reentry at orbital velocities (e.g., approximately Mach 22.5 at a typical shuttle altitude of 300 km, or 185 miles). The glider will employ a “feathering” technique to manage drag during the unpowered descent and landing. SpaceShipTwo is expected to use a single hybrid rocket motor to launch from mid-air after detaching from a mother ship at 50,000 feet, unlike NASA's space shuttle's ground-based launch.

With the dawn of space tourism and other adventure (e.g., bungee jumping) or sports activities (e.g., pole vaulting) comes the necessity to imagine new forms of memorializing the sensations experienced in activities, for example, that hurl the body into the air with little to no protective restraints or push the boundaries of the body's normal activity. In the moment of weightlessness (e.g., experienced in space tourism)—the sense of awe, calm and the beauty of a body free of earth's gravity being at the heart of those memories. The disclosed souvenir and imaging capture method and system can render the essence of that experience beyond mere images.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for a method and system for scanning a suspended body or bodies.

It is another aspect of the present invention to provide for a method and system for creating 3D laser-induced images of suspended body or bodies within a transparent material utilizing one or more scanners and etching machine(s).

It is a further aspect of the present invention to provide for a method and system of capturing 3D data of the human body in a moment of movement and transposing that data in a solid material for the purpose of generating a scaled down simulation of that moment.

It is yet an additional aspect of the present invention to provide for a method of capturing 3D data of the human body in a moment of movement and transposing that data in a solid material for the purpose generating a scaled down simulation of that moment, whereby a physical subject is transferred to a virtual model which is intern scaled down to a physical model that corresponds almost identically to the original subject.

The aforementioned aspects and other objectives and advantages can now be achieved as described herein. Methods and systems for creating 3D laser-induced images of a body or bodies suspended in air inside a transparent material by way of using a scanner (e.g. a laser scanner) to optically scan an environment and stop action are disclosed. The same 3D data may be utilized to construct portraits of individuals through 3D laser etching, 3D laser cutting, 3D printing (or any form of rapid prototyping)

The disclosed embodiments provide an individual (or group of individuals) with a physical representation of an experience that a photograph or video could not capture (e.g., a view of the body suspended in air from multiple angles). A 3D image of such individuals can be etched in optical glass or another appropriate transparent medium. Due to the etching of the 3D image etched in a transparent material, such as, for example, optical glass, the image will never fade or be diminished. Photography and video, for example, are unstable mediums with limited life spans.

The disclosed embodiments can apply to any activity where a body (or bodies) may be suspended in space. Because the nature of the etched portrait is to capture a 3D image of the body or bodies at all angles (e.g., top, bottom, front, back, left, right), the body or bodies should preferably not be touching the surface of any structure (e.g., a person climbing the wall of a rock climbing gym would not be an ideal activity for this application due to the fact that the person is gripped onto and facing a wall). A body attached to objects, however, is applicable (e.g., bungee jumper, a person doing skateboard tricks in the air, a pole vaulter, etc.) Appropriate applications for the disclosed embodiments include activities such as, for example, space tourism, adventure sports, amusement park rides, Olympic training facilities/games, and the like.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of system for capturing and creating 3D laser-induced images of target object(s) suspended in air inside a transparent material utilizing one or more scanners to optically scan an environment and stop action;

FIG. 2 illustrates a technical snapshot of a spacecraft, which can be utilized for space tourism purposes, and in which an embodiment of the present invention may be implemented;

FIG. 3 illustrates a pictorial representation of a souvenir, which can include a 3D view of the target object(s) (e.g., body or bodies), in accordance with an embodiment;

FIG. 4 illustrates a representation of a group pose, in accordance with an embodiment;

FIG. 5 illustrates a representation of single body pose, in accordance with an embodiment;

FIG. 6 illustrates a representation of an alternative group pose, in accordance with an embodiment;

FIG. 7 illustrates a diagram of a system, depicting the location of a LIDAR scanner within spacecraft, in accordance with one possible embodiment; and

FIGS. 8-9 illustrate example laser etching machines, which may be utilized to etch optical glass, in accordance with an embodiment.

### DETAILED DESCRIPTION

The particular values and configurations discussed in these non-limiting examples can be varied and are cited merely to illustrate at least one embodiment and are not intended to limit the scope thereof.

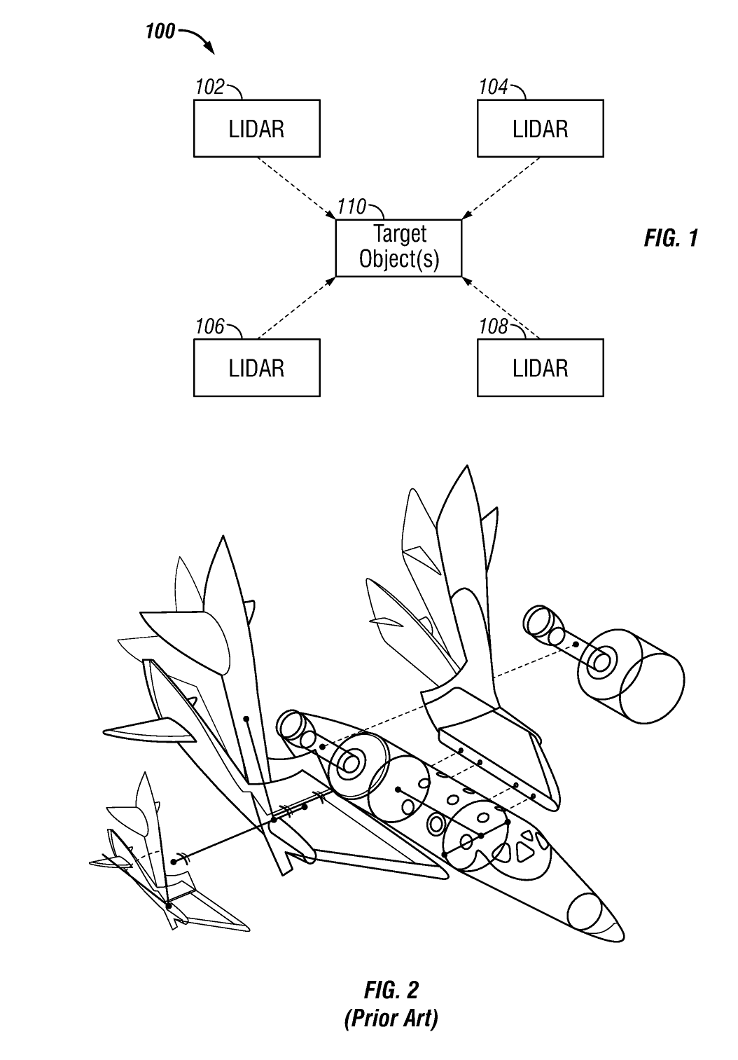

FIG. 1 illustrates a block diagram of system 100 for capturing and creating 3D laser-induced images of target object(s) 108 suspended in air inside a transparent material utilizing one or more scanners 102, 104, 106, and 108 to optically scan an environment and stop action. The target object(s) 110 may be, for example, one or more bodies suspended in air or in motion in an environment, such as, for example, an adventure sports environment, amusement park rides, Olympic training facilities/games, space tourism, and the like. Although a variety of applications are appropriate for the disclosed methods and systems, the discussion herein will focus on space tourism as one possible (but not the only) application.

A number of different types of scanners may be utilized to implement the scanners 102, 104, 106 and/or 108. One example of such a scanner is disclosed in U.S. Patent Application Publication No. 20060245717, entitled “Laser scanner and method for optically scanning an environment,” which was published on Nov. 2, 2006 by Martin Ossig, et al. U.S. Patent Application Publication No. 20060245717, which is incorporated herein by reference, discloses a laser scanner for optically scanning and measuring an environment comprises a light transmitter having a predetermined transmission power for emitting a light beam. The emitted light beam is reflected at a measurement point in the environment. The reflected light beam is received with certain intensity by a receiver. The transmission power is adjustable as a function of the intensity of the reflected light beam. Furthermore, a gray-scale value of the measurement point is determined as a function of the transmission power adjusted.

Another example of a scanner that can be utilized to implement scanners 102, 104, 106 and/or 108 is disclosed in U.S. Pat. No. 7,067,812, entitled “Multispectral selective reflective Lidar,” which issued to Gelbwachs on Jun. 27, 2006. U.S. Pat. No. 7,067,812, which is incorporated herein by reference, discloses a multispectral selective reflection Lidar system generates alternating pulses of at least two wavelengths and senses returns for determining the presence of a predetermined material absorbing and reradiating one wavelength as selective reflections, but not the other. A detector can readily determine the presence or absence or an absorbing and reradiating return. The system is for preferred use as an orbiter sensor about a planetary body, such as a Jupiter moon, for determining the presence of organic material and for the relay of information back to earth.

A further example of a scanner or laser scanning approach that can be utilized to implement scanners 102, 104, 106 and/or 108 is disclosed in U.S. Pat. No. 7,164,518, entitled “Fast scanner with rotatable mirror and image processing system,” which issued to Yang on Jan. 16, 2007. U.S. Pat. No. 7,164,518, which is incorporated herein by reference, discloses a scanner for obtaining an image of an object placed on an at least partially transparent platform, wherein the platform is defined by edge portions and has at least including a first scan area and a second scan area. In one embodiment, the scanner includes a white area formed at least partially around the edge portions of the platform with a plurality of markers, optical means for sequentially scanning consecutive partial images of the object from the first scan area and the second scan area, respectively, wherein each of the consecutive partial images include an image of at least one of the plurality of markers, and an image processing system for using the image of the at least one of the plurality of markers in each of the consecutive partial images as a reference to combine the consecutive partial images so as to form a substantially complete image of the object corresponding to a full scan of the first scan area and the second scan area.

An additional example of a scanning approach that can be utilized to implement scanners 102, 104, 106 and/or 108 is disclosed in U.S. Pat. No. 7,450,132 entitled “Method and/or apparatus for high speed visualization of depth image-based 3D graphic data,” which issued to Park, et al. on Nov. 11, 2008. U.S. Pat. No. 7,450,132, which is incorporated herein by reference, describes a method and/or apparatus for high speed visualization of depth image-based 3D graphic data. The method includes: reading point texture data of a 3D object; performing a 3D warping for each of the reference images of the simple texture data at a predetermined view point to obtain warped images; performing a depth test and a splatting for each pixel of the plurality of warped images to obtain final color data; and visualizing an object by using the final color data. Accordingly, it is possible to reduce memory usage and increase the number of visualization per a second and to effectively implement visualization of 3D graphic object in, particularly, a mobile terminal.

FIG. 2 illustrates a technical snapshot of a spacecraft 200, which can be utilized for space tourism purposes, and in which an embodiment of the present invention may be implemented. In the context of space tourism, to successfully capture the necessary digital information of the interior of the spacecraft 200 in flight and in zero-gravity environment, approximately, the four scanners 102, 104, 106, and 108 can be placed in an area of the passenger cabin of the spacecraft. Note that the scanners 102, 104, 106 and/or 108 may be implemented as laser scanners, such as, for example, LIDAR (Light Detecting and Ranging) scanners or other appropriate types of scanning devices. During the flights period of weightlessness, wherein the astronauts are free to move about the cabin, the scanners in sequence with one another can be employed to capture a number of “scenes” at a minimum of, for example, 1/250th of a second. A soft audio announcement in the form of multiple, single brass bowl chimes can notify the astronauts/passengers that a scene is about to be captured. This will allow the astronauts/passengers to prepare a pose for a group or single portrait.

Once a mission has ended and the spacecraft 200 has completed its egress onto a tarmac, the digital files can be removed from the spacecraft 200 by a “souvenir technician.” Once inside the spaceport, the souvenir technician can assemble the various files into full 3D models of the passengers floating in the cabin of the spacecraft 200. During the astronaut/passenger “de-briefing” session, the astronauts/passengers can select a scene of themselves or with other astronauts from the mission from a number of 2D illustrations. Once a scene has been selected by the astronaut(s), the souvenir technician further prepares the digital file, from which the file then used to etch the scene into a solid optical glass form in the shape of the interior cabin of the spacecraft 200 or another appropriate or desired shape.

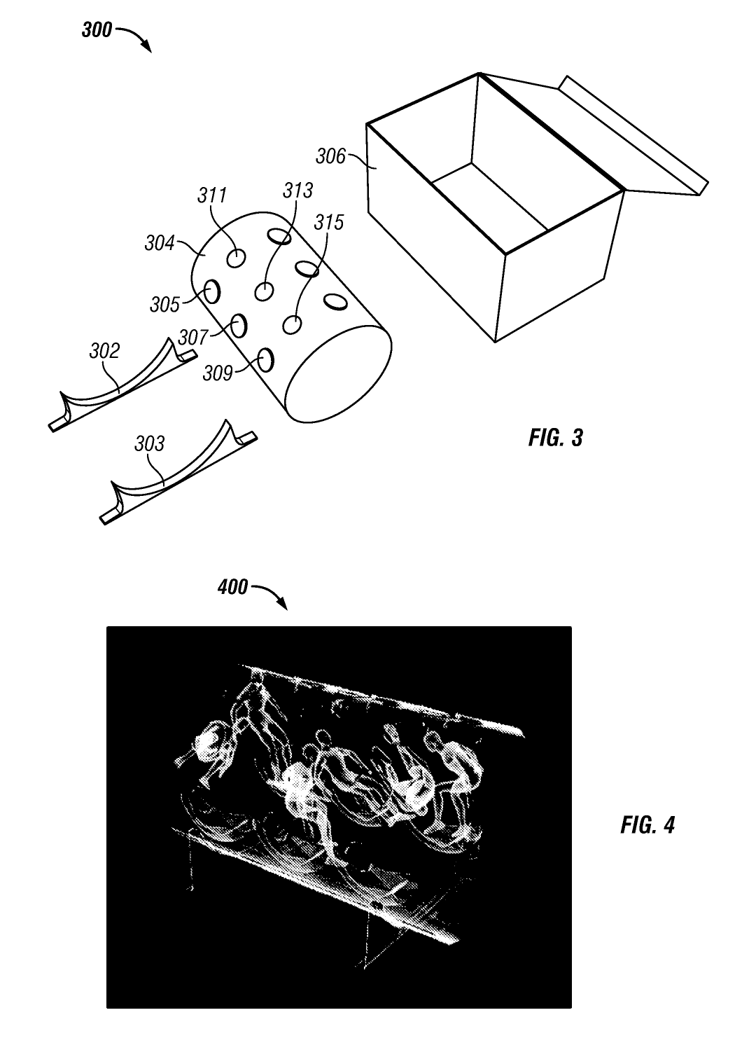

FIG. 3 illustrates a pictorial representation of a souvenir 300, which can include a 3D view of the target object(s) 108 (e.g., body or bodies), in accordance with an embodiment. The souvenir 300 generally includes glass stands 302, 303 in association with a solid optical glass cylinder 304, which is configured as a representation of the cabin or other appropriate portion of the spacecraft 200. In the example depicted in FIG. 3, a variety of raised portions 305, 307, 309, 311, 313, 315 etc. are depicted, which are representative of respective window sills associated with the spacecraft 200. A protective box 306 can also be provided with respect to the glass stands 302, 303 and the glass cylinder 304.

When the scene has finished etching into the optical glass cylinder 304 (or another appropriate/different shape), the resulting souvenir (e.g., the glass stands 302, 303 and the glass cylinder 304) can be placed in the special protective showcase box 306. Later in the afternoon, for example the astronauts/passengers can be presented with their “Zero-Gravity Frozen” souvenir 300. This “Zero-Gravity Frozen” souvenir 300 can be configured with, for example, these four basic elements: a representation of the spacecraft's optical glass cabin 304, two glass stands 302, 303, and the protective box 306. The representation of the spacecraft's optical glass cabin may be, for example, approximately, 12.4 centimeters in diameter and 19.05 centimeters in length. As indicated in the example illustration of FIG. 4, it is the intention of the solid optical glass form to have reliefed disks slightly protruding from the surface of the glass cylinder 304. To further reference that the solid optical glass form resembles an interior casting of a cabin associated with spacecraft 200, the circle sills and window diameters of the spacecraft's windows can be integrated into the basic cylinder form.

Each optical glass souvenir 300 can contain a scene from the cabin of the spacecraft 200 during the zero-gravity portion of the mission. Within the scene, the chairs, for example, (in their reclined position) can be etched into the glass to bring an environmental authenticity of the experience. Each astronaut may have the option of different portraits of themselves in this scene within the spacecraft 200.

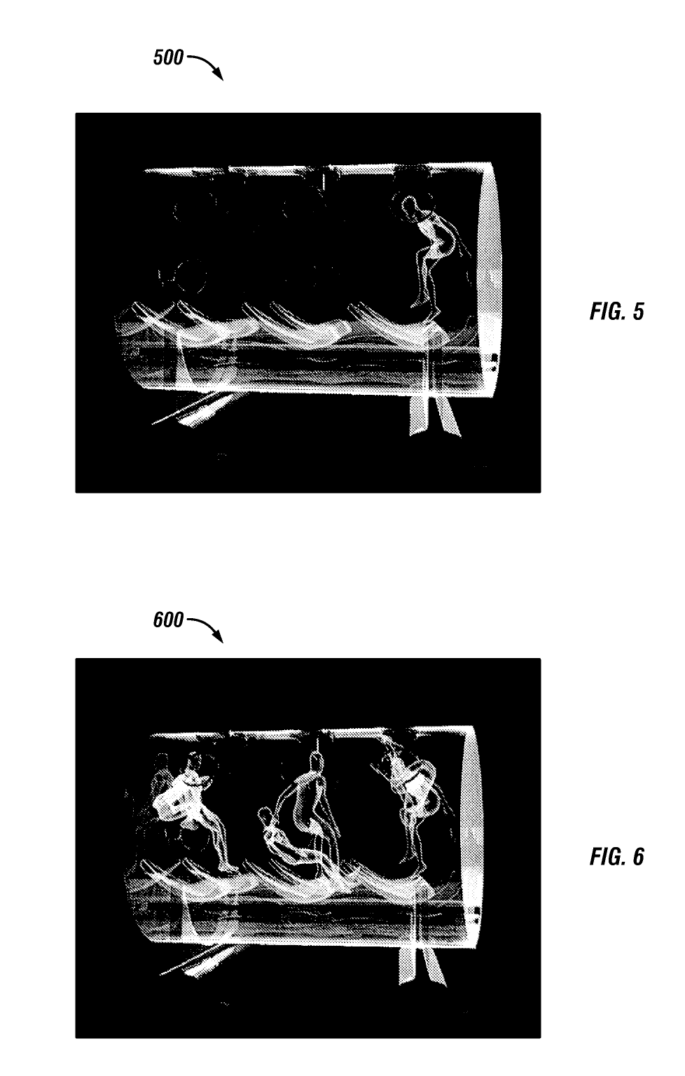

If an astronaut is accompanied by family members or friends on the mission, then any type of group pose can be accommodated, as shown in the representation 400 depicted in FIG. 4. Alternatively, if an astronaut is on the mission by him/herself, all other astronauts can easily be removed from the scene as long as no other astronaut is making body contact with that astronaut. The representation 500 depicted in FIG. 5 illustrates a single passenger/astronaut within the spacecraft 200. The representation 600 illustrated in FIG. 6 depicts an alternative group rendering. No special set up is required during the scanning of the cabin of the spacecraft 200.

Regarding stop motion capabilities, a special set of scans can take place during this time, indicated to the astronauts with a special audio announcement, whereby six scans, for example, can rapidly be taken one after the other. This will provide an astronaut to capture him/herself in a series of six sequential gestures. By seeing moments of the body moving in weightlessness, an astronaut is provided an unprecedented opportunity to visually “feel” himself/herself moving in zero-gravity. During these sequences of scans, the astronaut should not come into contact with any other astronaut or parts of the cabin of the spacecraft 200.

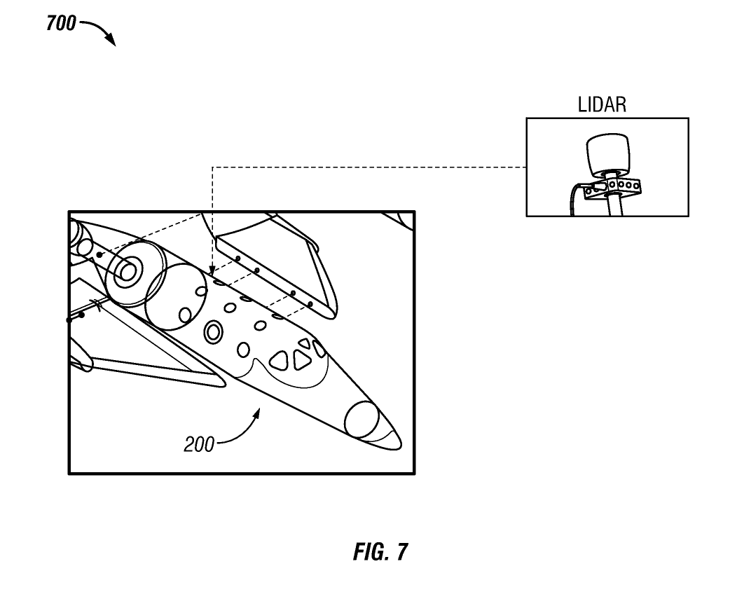

FIG. 7 illustrates a diagram of a system 700, depicting the location of a LIDAR type scanner within spacecraft 200, in accordance with one possible embodiment. Note that in FIG. 1-8, identical or similar parts are generally indicated by identical reference numerals or markings. For example, the spacecraft 200 depicted in FIG. 7 is the same spacecraft 200 depicted in FIG. 2. The LIDAR scanner shown in FIG. 7 is similar or representative of the scanners 102, 104, 106, and 108 depicted in FIG. 1. It can, of course, be appreciated, that other types of scanners may be utilized in place of LIDAR scanners. The interior cabin of the spacecraft 200 can thus be installed with one or more, but preferably at least four scanners, such as LIDAR scanners 102, 104, 106, and 108. Such scanners 102, 104, 106, and 108 can be synced so as to capture data from all four cardinal directions simultaneously. The data from each scanner 102, 104, 106, and 108 can be then spliced together to create a complete 3D image.

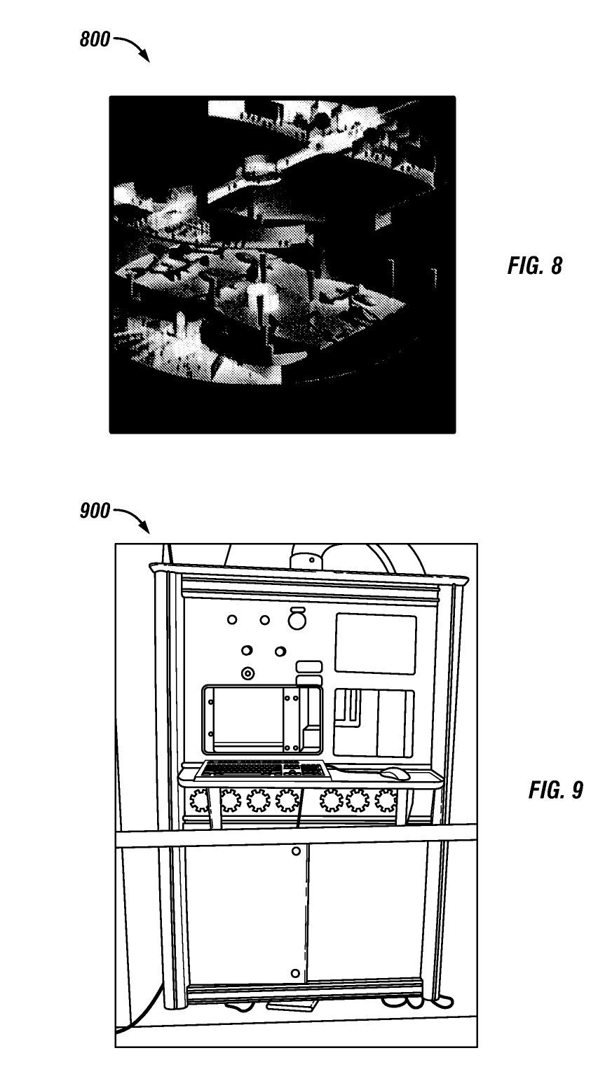

FIG. 8 illustrates an example of an etching machine 800, which may be utilized to etch the optical glass, in accordance with an embodiment. FIG. 9 illustrates an example of an alternative etching machine 900, which may be utilized to etch the optical glass, in accordance with an embodiment. To etch the optical glass forms, a space should be allocated to accommodate an etching machine, such as, for example, etching machine 800 or 900, and the computer to operate the machine and to prepare the 3D files. In addition, storage space may possibly be required to store unetched optical glass forms, as well as the protective display boxes. Note that a number of etching devices and approaches may be utilized to implement the etching machine 800 or 900.

One example of an etching device, which may be utilized to implement etching machine 800 or 900 is disclosed in U.S. Pat. No. 7,060,933, entitled “Method and laser system for production of laser-induced images inside and on the surface of transparent material,” which issued to Burrowes, et al. on Jun. 13, 2006. U.S. Pat. No. 7,060,933, which is incorporated herein by reference, describes a method and an apparatus for creating laser-induced images inside transparent materials and on their surfaces is disclosed. The method is founded on the production of etch points by creating breakdowns at the predetermined points inside transparent material and by creating breakdowns at the predetermined points of the air or another environment. Mark areas on the transparent material surfaces are the frost areas and a surface image is an arrangement of the frost areas of different density. Such frost areas on the surface of a transparent material are produced by the plasma generated during breakdowns. A method and a system for controlling characteristics of plasma generated during breakdowns for controlling the parameters of the frost areas arisen under interaction of the plasma with the surface of the transparent material are disclosed.

Another example an etching device, which may be utilized to implement etching machine 800 or 900 is disclosed in U.S. Pat. No. 6,740,846, entitled “Method for production of 3D laser-induced head image inside transparent material by using several 2D portraits,” which issued to Troitski, et al on May 25, 2004. U.S. Pat. No. 6,740,846, which is incorporated herein by reference, discloses a method for creating 3D laser-induced head image inside transparent material is disclosed. Initial information for this creation is several 2D portraits. Creation of 3D laser-induced head image has three stages. The first stage is the construction of 3D head model from corresponding principal parts detailed from given 2D portraits and creation of the bearing point arrangement by covering the model by equidistance points. This bearing point arrangement gives information only about spatial configuration of points. The second stage is transformation of the bearing point arrangement into point arrangement, which has more complete information about portraits. The third stage is production of a plurality of the etch points inside a transparent material by a laser beam, which is periodically focused at the points belonging to the transformed point arrangement.

Based on the foregoing, it can be appreciated that a method and system for creating 3D laser-induced images of a body or bodies suspended in air within a transparent material by way of using the scanner to optically scan an environment and stop action are disclosed. The same 3D data may be utilized to construct portraits of individuals through 3D laser etching, 3D laser cutting, 3D printing/rendering (or any form of rapid prototyping). Multiple scanners such as scanners 102, 104, 106 and 108 can be utilized to capture a complete person three dimensionally—laser scans on all X, Y, Z planes—thereby enabling a method for synchronizing scans. In addition, a method and system for constructing a complete three-dimensional data model from multiple data is disclosed.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system, comprising:
a plurality of scanners located with respect to a target body, wherein said plurality of scanners scans said target body generate data indicative of said target body; and
an etching machine that receives said data and etches a transparent material with a representation of said target body based on said data indicative of said target body.

2. The system of claim 1 wherein each scanner among said plurality of scanners comprises a laser scanner.

3. The system of claim 1 wherein said data indicative of said target body comprises 3D data.

4. The system of claim 1 wherein said representation of said target body comprises a 3D portrait of said target body.

5. The system of claim 1 wherein said etching machine laser cuts said transparent material with said 3D portrait of said target body.

6. The system of claim 1 wherein said target body at a moment of scanning by said plurality of scanners is located in a zero-gravity environment.

7. A system, comprising:
a plurality of scanners located with respect to a target body, wherein said plurality of scanners scan said target body generate data indicative of said target body, wherein each scanner among said plurality of scanners comprises a laser scanner; and
an etching machine that receives said data and etches a transparent material with a representation of said target body based on said data indicative of said target body.

8. The system of claim 7 wherein said data indicative of said target body comprises 3D data.

9. The system of claim 7 wherein said representation of said target body comprises a 3D portrait of said target body.

10. The system of claim 7 wherein said etching machine laser cuts said transparent material with said 3D portrait of said target body.

11. The system of claim 7 wherein said target body at a moment of scanning by said plurality of scanners is located in a zero-gravity environment.

12. A method, comprising:
scanning a target body to generate data indicative of said target body; and
etching a transparent material with a representation of said target body based on said data indicative of said target body.

13. The method of claim 12 further comprising locating a plurality of scanners with respect to said body, wherein said plurality of scanners scans said target body to generate said data indicative of said target body.

14. The method of claim 12 further comprising utilizing an etching machine to etch said transparent material with said representation of said target body based on said data indicative of said target body.

15. The method of claim 13 wherein each scanner among said plurality of scanners comprises a laser scanner.

16. The method of claim 13 wherein said data indicative of said target body comprises 3D data.

17. The method of claim 13 wherein said representation of said target body comprises a 3D portrait of said target body.

18. The method of claim 13 wherein said etching machine laser cuts said transparent material with said 3D portrait of said target body.

19. The method of claim 13 wherein said target body at a moment of scanning by said plurality of scanners is located in a zero-gravity environment.

20. The method of claim 13 further comprising:
locating a plurality of scanners with respect to said body, wherein said plurality of scanners scans said target body to generate said data indicative of said target body;
utilizing an etching machine to etch said transparent material with said representation of said target body based on said data indicative of said target body; and
wherein said representation of said target body comprises a 3D portrait of said target body.
